(19) United States
(12) Patent Application Publication
(10) Pub. No.: US 2009/0095915 A1
(43) Pub. Date: Apr. 16, 2009

(54) PORTABLE RADIATION DETECTION SYSTEM AND METHOD

(75) Inventors: Fernando A. Ferraro, Apollo, PA (US); Robert K. Davis, Pittsburgh, PA (US); Joseph Grosholz, JR., Natrona Heights, PA (US)

Correspondence Address: THE WEBB LAW FIRM, P.C., 700 KOPPERS BUILDING, 436 SEVENTH AVENUE, PITTSBURGH, PA, 15219, US

(73) Assignee: EV PRODUCTS, INC., Saxonburg, PA (US)

(21) Appl. No.: 12/248,359

(22) Filed: Oct. 9, 2008

Related U.S. Application Data
(60) Provisional application No. 60/979,114, filed on Oct. 11, 2007.

(51) Int. Cl. G01T 1/24

(52) U.S. Cl. 250/370.13

(57) ABSTRACT

A radiation detection system includes a radiation detector and a DC/DC converter that induces an electric field in the radiation detector. A counter circuit outputs a pulse related to the energy of each incoming radiation event on the radiation detector. The peak amplitude of each pulse output by the counter circuit is converted into a digital equivalent value. A means for processing processes each digital equivalent value and counts a number of pulses output by the counter circuit over an interval of time. A port has one or more data lines connected to the means for processing and one or more power lines connected to the DC/DC converter. The port facilitates a connection to a host system which provides a single DC voltage to the DC/DC converter which converts the single DC voltage into a higher level voltage that induces the electric field in the radiation detector.

### CROSS REFERENCE TO RELATED APPLICATION

The present application claims priority from U.S. Provisional Patent Application No. 60/979,114, filed Oct. 11, 2007, entitled “Programmable Gamma Ray Spectroscopy Module”, which is incorporated herein by reference.

### BACKGROUND OF THE INVENTION

1. Field of the Invention

The present invention relates to radiation detection systems and, more particularly, to a portable radiation detection system, including a radiation sensor module, that can be coupled to a host system, such as a desktop or laptop (or portable) computer.

2. Description of Related Art

The ability to detect radiation is important in many security and environmental monitoring applications. However, the ability to reliably detect radiation is only the first step in the threat assessment process. For homeland security applications, the radiation present may be from a naturally occurring, medical or natural isotope and of no concern. It is therefore important to classify the radiation present through spectroscopy.

Current state of the art portable spectroscopy systems employ off-the-shelf radiation detectors, electronics and isotope identification algorithms. While these systems can be optimized for specific applications, they are bulky, expensive and not intended to function as sensor level devices.

Recently, fully integrated radiation sensor modules have become available that are small, low power, sensor level devices. However, these devices cannot perform spectroscopy because they lack the necessary electronics and spectroscopy grade detector. Therefore, these devices can only detect the presence of radiation and cannot classify the radiation isotope.

### SUMMARY OF THE INVENTION

The invention is a portable radiation detection system. The system includes a radiation detector including a cathode terminal and an anode terminal on different sides of a core material that produces electron-hole pairs in response to incoming radiation events; a DC/DC converter operatively coupled to the radiation detector for inducing an electric field in the core material that extends between the cathode terminal and the anode terminal; means responsive to each incoming radiation event on the core material for outputting an electrical pulse having an amplitude related to the energy of the incoming radiation event; means for converting a peak amplitude of each pulse output by the means for outputting into a digital equivalent value; means for processing the digital equivalent value and for counting a number of pulses output by the counter circuit over an interval of time; and a port having one or more data lines connected to the means for processing and one or more power lines connected to the DC/DC converter, said port operative for facilitating a connection to a host system which provides a single DC voltage to the DC/DC converter which converts the single DC voltage into a higher level voltage that induces the electric field in the core material of the radiation detector.

The single DC voltage can be a nominal 5 volts DC. The higher level voltage output by the DC/DC converter can be between −300 volts DC and −2,000 volts DC.

The system can further include a differential amplifier and a shaper in series from the anode terminal to the means for outputting.

The anode terminal can be either a sheet anode or an interdigitated anode.

The host system can be either a laptop (or portable) computer or a desktop computer.

The system can further include a low voltage regulator coupled to the one or more power lines of the port, said low voltage regulator responsive to the single operating voltage provided by host system for supplying one or more operating voltages to the counter circuit, the means for converting the peak amplitude of each pulse output by the means for outputting into a digital equivalent value, and the means for processing.

The invention is also a radiation detection method comprising: (a) providing a sensor module having signal processing electronics, a port operatively coupled to a DC/DC converter and a radiation detector operatively coupled to a DC/DC converter; (b) operatively coupling a host system to the port, whereupon the host system provides a single voltage DC power to the DC/DC converter which supplies operating voltage to the radiation detector; (c) causing the signal processing electronics to process the output of the radiation detector in response to incoming radiation events on the radiation detector into corresponding digital data; and (d) dispatching the digital data to the host system via the port.

The method can further include the host system displaying a graph based on the digital data.

The digital data can include at least one of the following: a total number of radiation events seen by the radiation detector in a given period of time; the energy of each radiation event seen by the radiation detector; accumulated energy spectrum seen by the radiation detector; directional information of the source of the radiation events detected by the radiation detector; radiation dose rate; an identified isotope from the source of the radiation events; and/or a safe or unsafe radiation condition.

The signal processing electronics can determine for each incoming radiation event a peak value related to the energy of the radiation event and can accumulate a count of a number of incoming radiation events over an interval of time.

The method can further include disconnecting the host system from the port of the sensor module and connecting another host system to the port of the sensor module, whereupon the DC/DC converter receives single voltage DC power from the other host system.

### BRIEF DESCRIPTION OF THE DRAWINGS

FIG. 1 is a block diagram of a portable radiation detection system including a host system coupled to a sensor module in accordance with the present invention;

FIGS. 2A and 2B are block diagrams of a sheet anode and an interdigitated anode, respectively, connected to circuitry of the ASIC of the sensor module shown in FIG. 1;

FIG. 3 shows an exemplary arrangement of switches and external resistors coupled to the differential amplifier shown in FIGS. 2A and 2B for controlling the gain thereof;

FIG. 4 is a detailed electrical schematic of an exemplary shaper circuit shown in FIGS. 2A and 2B; and

FIG. 5 is an exemplary graph of counts (pulses) versus photon (radiation) energy that the host system of FIG. 1 can display on the display of FIG. 1.

### DETAILED DESCRIPTION OF THE INVENTION

The present invention will be described with reference to the accompanying figures where like reference numbers correspond to like elements.

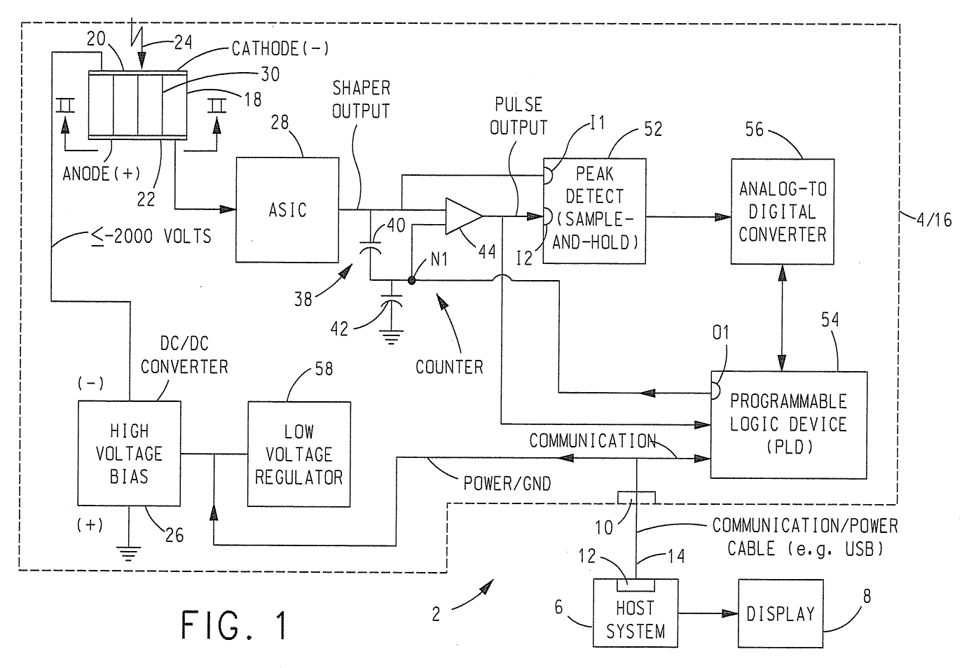

With reference to FIG. 1, a portable radiation detection system 2 includes a sensor module 4 coupled to a host system 6 that includes an integral or standalone display 8. The connection between sensor module 4 and host system 6 is accomplished by way of ports 10 and 12 of sensor module 4 and host system 6, respectively, via a cable 14. In one embodiment, ports 10 and 12 are USB type ports and cable 14 is a USB type cable. However, this is not to be construed as limiting the invention since it is envisioned that ports 10, 12 and cable 14 can be of any suitable and/or desirable type, such as, without limitation, SPI, IIC, Fire Wire, 8-bit parallel and 16-bit parallel. For the purpose of discussion, hereinafter ports 10, 12 and cable 14 will be described as being USB type ports 10, 12 and a USB type cable 14.

In one embodiment, a laptop (or portable) computer comprises host system 6 and display means 8. Alternatively, host system 6 can be a desktop computer having a separate display 8.

USB cable 14 includes two conductors for signals, one conductor for power and one conductor for ground. In accordance with the present invention, sensor module 4 derives all its operating power from host system 6 via the power and ground conductors of USB cable 14. A benefit of this arrangement is that sensor module 4 can be utilized with different host systems 6 simply by reconnecting USB cable 14 from the USB port of one host system to the USB port of another host system.

Typically, the voltage that can be supplied by a USB connection can vary from 4.4 volts DC to 5.25 volts DC (nominally 5 volts DC). In accordance with the present invention, sensor module 4 is configured to operate from such voltages.

In practice, sensor module 4 includes the components shown in block diagram form in FIG. 1 mounted on a printed circuit board. In one exemplary, non-limiting embodiment, sensor module 4 has dimensions of about 47 mm×44 mm×28 mm. However, this is not to be construed as limiting the invention. Sensor module 4 can then be included in a suitably sized housing 16 whereupon housing 16 and sensor module 4 are readily portable. Because sensor module 4 derives all of its electrical power from host system 6 via USB cable 14, the weight and dimensions of the combination of sensor module 4 and housing 16 can be kept to a minimum.

While host system 6 is described above as being a laptop (or portable) computer or a desktop computer, it is also envisioned that host system 6 can be any other suitable and/or desirable device that includes a USB port, such as, without limitation, a pager or a cell phone. Accordingly, the description herein of host system 6 being a laptop (or portable) computer or a desktop computer is not to be construed as limiting the invention.

With ongoing reference to FIG. 1, sensor module 4 includes one or more radiation detectors 18 having a core material made from a suitable compound semiconductor, such as, without limitation, cadmium zinc telluride (CdZnTe). Radiation detector 18 includes cathode 20 and anode 22 terminals on opposite sides thereof. In response to interaction with incoming radiation, such as an incoming photon 24, the core material of radiation detector 18 forms electron-hole pairs. Cathode 20, in the form of a conductive sheet, is connected to a high voltage bias circuit 26 in the form of a DC/DC converter that converts the DC voltage provided to sensor module 4 from host system 6 via USB cable 14 into a suitable negative voltage that can be applied to cathode 20. In one non-limiting embodiment, the voltage applied to cathode 20 by high voltage via circuit 26 is between −300 volts DC and −2,000 volts DC.

On the other hand, anode 22 is connected to the input of an ASIC 28, which input is biased to a voltage that enables a suitable strength electric field 30 to form between cathode 20 and anode 22 in the core material of radiation detector 18.

Under the influence of electric field 30, electrons generated in the crystal material of radiation detector 18 in response to incoming radiation events travel toward the input of ASIC 28 for processing. More generally, in response to receiving an incoming radiation event, anode 22 outputs a corresponding signal to the input of ASIC 28.

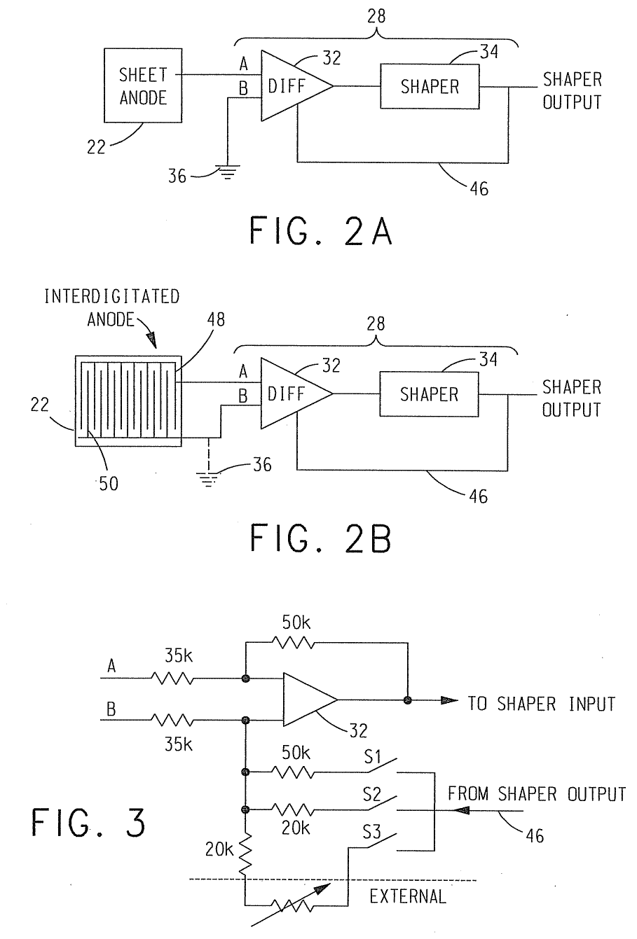

With reference to FIGS. 2A and 2B and with continuing reference to FIG. 1, anode 22 can be realized in the form of a sheet anode (FIG. 2A) or an interdigitated anode (FIG. 2B).

As shown in FIGS. 2A and 2B, ASIC 28 includes, among other things, a difference amplifier 32 and a shaper 34.

In the embodiment of ASIC 28 shown in FIG. 2A, one input of difference amplifier 32 is connected to anode 22 in the form of a sheet while the other input of difference amplifier is connected to a reference ground 36. The output of difference amplifier 32 is coupled to an input of shaper 34.

As shown in FIG. 1, the output of shaper 34 (shaper output) is coupled to a counter circuit 38 comprised of capacitors 40 and 42 and a difference amplifier 44 connected as shown. The output of shaper 34 (shaper output) is also coupled to one input of a peak detect (sample-and-hold) circuit 52. As shown in FIGS. 2A and 2B, the output of shaper 34 is also coupled back to difference amplifier 32 in a feedback mode via a line 46.

With specific reference to FIG. 2B, when anode 22 is in the form of an interdigitated anode, one set of fingers 48 can be connected to one input of difference amplifier 32 while the other set of fingers 50 can be connected to the other input of difference amplifier 32. Also or alternatively, one of the sets of fingers 48 or 50 can be connected to a reference voltage 36, e.g., a reference ground, as shown in phantom in FIG. 2B. In FIG. 2B, the connection of difference amplifier 32 and shaper 34 is the same as described above in connection with FIG. 2A.

With reference to FIG. 3 and with continuing reference to FIGS. 1, 2A and 2B, in one exemplary, non-limiting embodiment, the relative gain of difference amplifier 32 can be adjusted through a combination of switches S1 through S3 and external resistors as shown. Also or alternatively, however, difference amplifier 32 can have a fixed gain simply by connecting a suitable value resistor in line 46 between the output of shaper 34 and the input of difference amplifier 32.

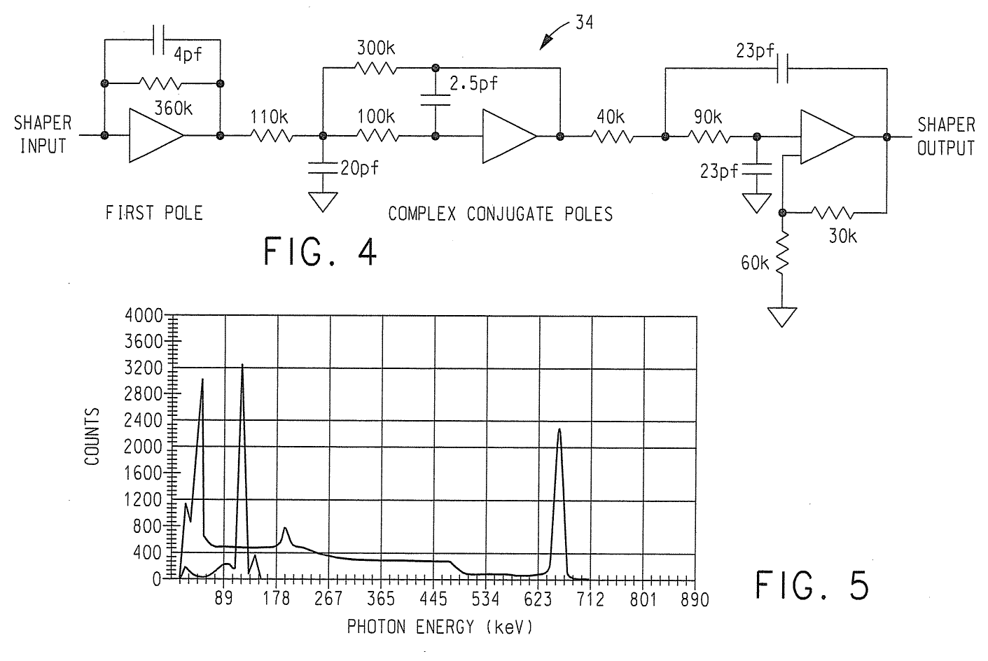

With reference to FIG. 4 and with continuing reference to FIGS. 1-3, in one non-limiting embodiment, shaper 34 can comprise the fifth-order filter with complex conjugate poles shown in FIG. 4.

The disclosure of the switches and external resistors in FIG. 3 and the particular embodiment of shaper 34 in FIG. 4 are not to be construed as limiting the invention since it is envisioned that any suitable and/or desirable circuitry for processing signals output by anode 22 can be utilized.

With reference back to FIG. 1, the output of shaper 34 is provided to counter circuit 38 which converts each signal output by shaper 34 into a discrete pulse (or count) having an amplitude related to the energy of the incoming radiation event. Each pulse output by counter circuit 38 is provided to another input of peak detect (sample-and-hold) circuit 52 and a programmable logic device (PLD) 54.

Peak detect circuit 52 is operative to sample the peak output of each pulse output by shaper 34 (shaper output) present at the one input (I1) of peak detect circuit 52 in response to the other input (I2) of peak detect circuit 52 detecting a suitable change in state in the output of difference amplifier 44 of counter circuit 38 in response to the amplitude of the pulse output by shaper 34 exceeding a threshold level established by capacitor 42. Peak detect circuit 52 then provides said sampled peak output to an analog-to-digital converter 56. Under the control of PLD 54, analog-to-digital converter 56 converts each peak output presented to the input of analog-to-digital converter 56 into a corresponding digital signal which is provided to PLD 54 for subsequent processing and/or forwarding to host system 6 via USB cable 14.

PLD 54 is also operative for counting the number of pulses output by difference amplifier 44 of counter 38 during one or more given intervals of time. In one exemplary, non-limiting embodiment, PLD 54 is operative for counting up to 25,000 pulses output by difference amplifier 44 of counter circuit 38 per second (25,000 counts per second). PLD 54 is further operative for providing the number of pulses output by counter circuit 38 during a given interval of time to host system 6 via USB cable 14. PLD 54 also includes a threshold adjust output (O1) coupled to a node (N1) between capacitors 40 and 42. PLD 54 is operative for establishing on capacitor 42 the threshold level used by difference amplifier 44 for detecting the amplitudes of pulses output by shaper 34.

Host system 6 can comprise software and hardware capable of processing the data provided thereto by PLD 54 regarding the peak amplitude of each radiation event and the number of counts output by counter circuit 38 in a given interval of time into a plot of the number of pulses (counts) output by counter circuit 38 versus photon energy of the incoming radiation event. An exemplary plot of counts versus photon energy is shown in FIG. 5.

Sensor module 4 also includes a low voltage regulator 58 that receives power from host system 6 via USB cable 14. Low voltage regulator supplies power to the various electronic components of sensor module 4, including without limitation, ASIC 28, counter circuit 38, peak detect circuit 52, PLD 54 and analog-to-digital converter 56.

As can be seen, the present invention is a sensor module 4 that derives its operating power from a host system 6 via a simple connection (10, 12 and 14) therebetween. Because sensor module 4 derives its operating power from this connection, sensor module 4 can be used with host systems of various types, including laptop (or portable) computers, desktop computers, cell phones, pagers and/or any other suitable and/or desirable host system that is capable of supplying sufficient DC operating power to sensor module 4, as well as itself, and for optionally processing the output of PLD 54.

Advantages of sensor module 4 include the use of a single DC input voltage to provide all the operating voltages of radiation detector 18 as well as the electronic components of sensor module 4, and an output that is a digital signal (or stream) representing the radiation spectrum seen by the radiation detector 18. If desired, PLD 54 can be programmed to transmit to host system 6 any level of data available from radiation detector 18 and/or make decisions based on the available data.

While sensor module 4 is illustrated as having only a single radiation detector 18, a single ASIC 28, a single counter 38, a single peak detect 52 and a single analog-to-digital converter 56, it is envisioned that sensor module 4 is scalable whereupon it can include multiple radiation detectors 18 connected to suitable signal processing electronics in the manner of radiation detector 18 shown in FIG. 1.

The data contained in the digital signal (or stream) from sensor module 4 can include, without limitation, the total number of radiation events seen by radiation detector 18 in a given period of time; the energy of each radiation event seen by radiation detector 18; accumulated energy spectrum seen by radiation detector 18; directional information of the source of the radiation events detected by radiation detector 18; the radiation dose rate; the identified isotope(s) from the source of the radiation events; and/or safe or unsafe radiation conditions.

PLD 54 can be implemented in the form of a CPU an FPGA or other suitable and/or desirable logic device having access to multiple levels of signal data output by counter circuit 38 and/or analog-to-digital converter 56. PLD 54 can then select where in the signal chain to collect, process, and present data to host system 6. PLD 54 can also be programmed to power up or power down specific electronic components depending upon the current application specific requirements.

Examples of different programmed embodiments of sensor module 4 include: sensor module 4 providing buffered digital radiation event data to host system 6; sensor module 4 providing radiation data binned into energy spectrums to host system 6; sensor module 4 monitoring background radiation events at preset intervals, whereupon in response to a predetermined change in background radiation, PLD 54 can switch into full spectroscopy mode and provide data to host system 6; and sensor module 4 identifying isotope(s) present from spectral data and then sending information regarding these isotopes, dose rate and/or spectrum to host system 6.

As can be seen, sensor module 4 includes all the necessary components for radiation spectroscopy in a small, low power module.

The present invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A portable radiation detection system comprising:
a radiation detector including a cathode terminal and an anode terminal on different sides of a core material that produces electron-hole pairs in response to incoming radiation events;
a DC/DC converter operatively coupled to the radiation detector for inducing an electric field in the core material that extends between the cathode terminal and the anode terminal;
means responsive to each incoming radiation event on the core material for outputting an electrical pulse having an amplitude related to the energy of the incoming radiation event;
means for converting a peak amplitude of each pulse output by the means for outputting into a digital equivalent value;
means for processing the digital equivalent value and for counting a number of pulses output by the counter circuit over an interval of time; and
a port having one or more data lines connected to the means for processing and one or more power lines connected to the DC/DC converter, said port operative for facilitating a connection to a host system which provides a single DC voltage to the DC/DC converter which converts the single DC voltage into a higher level voltage that induces the electric field in the core material of the radiation detector.

2. The system of claim 1, wherein:
the single DC voltage is a nominal 5 volts DC; and
the higher level voltage output by the DC/DC converter is between −300 volts DC and −2,000 volts DC.

3. The system of claim 2 further including a differential amplifier and a shaper in series from the anode terminal to the means for outputting.

4. The system of claim 1, wherein the anode terminal is either a sheet anode or an interdigitated anode.

5. The system of claim 1, wherein the host system is either a portable computer or a desktop computer.

6. The system of claim 1, further including a low voltage regulator coupled to the one or more power lines of the port, said low voltage regulator responsive to the single operating voltage provided by host system for supplying one or more operating voltages to the means for outputting, the means for converting the peak amplitude of each pulse output by the counter circuit into a digital equivalent value, and the means for processing.

7. A radiation detection method comprising:
(a) providing a sensor module having signal processing electronics, a port operatively coupled to a DC/DC converter and a radiation detector operatively coupled to the DC/DC converter;
(b) operatively coupling a host system to the port, whereupon the host system provides a single voltage DC power to the DC/DC converter which supplies operating voltage to the radiation detector;
(c) causing the signal processing electronics to process the output of the radiation detector in response to incoming radiation events on the radiation detector into corresponding digital data; and
(d) dispatching the digital data to the host system via the port.

8. The method of claim 7, further including the host system displaying a graph based on the digital data.

9. The method of claim 7, wherein the digital data can include at least one of the following:
a total number of radiation events seen by the radiation detector in a given period of time;
the energy of each radiation event seen by the radiation detector;
accumulated energy spectrum seen by the radiation detector;
directional information of the source of the radiation events detected by the radiation detector;
radiation dose rate;
an identified isotope from the source of the radiation events; and/or
a safe or unsafe radiation condition.

10. The method of claim 7, wherein the signal processing electronics:
determines for each incoming radiation event a peak value related to the energy of the radiation event; and
accumulates a count of a number of incoming radiation events over an interval of time.

11. The method of claim 7, further including:
disconnecting the host system from the port of the sensor module; and
connecting another host system to the port of the sensor module, whereupon the DC/DC converter receives single voltage DC power from the other host system.

12. The method of claim 7, further including the host system displaying a graph based on the digital data.
